(19) United States
(12) Patent Application Publication
(10) Pub. No.: US 2020/0226233 A1
(43) Pub. Date: Jul. 16, 2020

(54) DISTRIBUTED LEDGER-BASED DIGITAL CONTENT PIRACY DETERRENCE

(71) Applicant: Combined Conditional Access Development and Support, LLC, Philadelphia, PA (US)

(72) Inventors: Madhu Penugonda, San Diego, CA (US); Eileen Bengston, Horsham, PA (US)

(21) Appl. No.: 16/246,123

(22) Filed: Jan. 11, 2019

(51) Int. Cl. G06F 21/16; H04L 9/06

(52) U.S. Cl. CPC G06F 21/16; H04L 9/0637; H04L 2209/38; H04L 2209/608; H04L 9/0643

(57) ABSTRACT

Methods and systems for distributed ledger-based digital content piracy deterrence may comprise receiving an indication of a content asset. An indication of a unique identifier associated with a user device may be received. A version of the content asset comprising a digital maker may to be sent to the user device. The digital marker may comprise an indication of the unique identifier of the user device. A distributed ledger record entry comprising an indication of the content asset and the unique identifier of the user device may be caused to be stored on a distributed ledger. The distributed ledger may comprise other record entries indicating other content assets and other unique identifiers associated with other user devices.

### BACKGROUND

There is a demand for direct-to-viewer releases of new movies, such as via video streaming (e.g., video on-demand, etc.). Currently, digital rights management (DRM) may be used to prevent unauthorized viewers from accessing content. However, DRM may not be sufficient to prevent unauthorized viewers from accessing content. Owners of content may not be willing to allow direct-to-viewer releases of valuable content until security techniques, such as techniques to prevent piracy of the content, beyond DRM protection are implemented. This is especially true for valuable content, such as 4K high-dynamic-range (HDR) content. Improvements in deterrence of video piracy are needed.

### SUMMARY

Systems and methods are described for digital content piracy deterrence using a distributed ledger. An indication of a content asset and an indication of a unique identifier associated with a user device, such as a unique identifier associated with a digital rights management (DRM) client on the user device, may be received. The user device may be determined to be authorized to access the content asset, such as based on the unique identifier. The content asset may comprise one or more frames of the content asset embedded with a digital marker, such as a watermark or a digital fingerprint. The digital marker may comprise an indication of the unique identifier. The content asset may be sent to the user device. A distributed ledger record entry may be caused to be stored on a distributed ledger. The distributed ledger record entry may comprise an indication that the user device requested the content asset and an indication of the unique identifier. The distributed ledger may comprise a plurality of records, comprising a plurality of record entries. The other entries may indicate content assets accessed by other devices and unique identifiers of the other devices.

### BRIEF DESCRIPTION OF THE DRAWINGS

The following drawings show generally, by way of example, but not by way of limitation, various examples discussed in the present disclosure. In the drawings:

FIG. 1 shows an example distributed system architecture.

FIG. 2 shows an example ledger architecture.

FIG. 3 shows an example distributed ledger architecture.

FIG. 4 shows an example system environment.

FIG. 5 shows a flow diagram of an example method.

FIG. 6 shows a flow diagram of an example method.

FIG. 7 shows a flow diagram of an example method.

FIG. 8 shows an example computing environment.

### DETAILED DESCRIPTION

Systems and methods are described for using distributed ledger-based technology for deterring digital content piracy using forensic digital marking, such as watermarking. The described systems and methods may enable automation and collaboration between different groups involved in the development of digital marker detection and piracy source identification technologies and vendors associated with digital marker technology and content distribution. Example systems and methods may comprise generating a key pair for a user device or assigning a key pair to the user device. Generating the key pair and/or assigning the key pair may be performed by a manufacturer of the user device or a content distributor associated with the user device. The key pair may be generated based on installation of software or firmware on the user device, such as a digital rights management (DRM) client on the user device. The key pair may comprise a private key and a public key. The key pair may have hardware Roots of Trust (RoT) and/or RoT in a trusted execution environment.

A unique identifier may be generated for the user device and/or assigned to the user device. For example, the unique identifier may comprise a series of hashes of the public key associated with the user device. The unique identifier may comprise the output of a one-way function. The one-way function may be configured such that the original key cannot be determined from the unique identifier. The unique identifier may comprise a unique identifier associated with the DRM client on the user device,

The number of bytes associated with the unique identifier may vary based on one or more factors. For example, a number of bytes associated with the unique identifier may depend on which entity generates and/or assigns the unique identifier. The unique identifier may be stored on the user device. The unique identifier may be stored in a database of unique identifiers, such as a database of unique identifiers of user devices and/or DRM clients associated with a content distributor.

The user device may send a request for content, such as for a specific content asset. The content asset may comprise video content or audio content, as examples. The request may be sent to a computing device, such as a license server and/or another device associated with a content distributor. The request may comprise an indication of the unique identifier of the user device. The request may comprise an indication of the content asset.

A determination may be made that the user device is authorized to access the content asset. Determining that the user device is authorized to access the content asset may comprise determining that the unique identifier or another indication of the user device is not on a blacklist. The blacklist may comprise a list of devices that are no longer authorized to access content. As an example, the blacklist may comprise indications of devices that are known to have sourced pirated content. Pirated content may comprise content that is distributed to a device or a user that does not have the authorization of a rights holder of the content to access the content.

Based on the determination that the user device is authorized to access the content asset, a version of the content asset comprising a digital marker, such as a watermark or a digital fingerprint, may be generated. The version of the content asset may comprise a copy of the content asset and/or another version of the content asset. The version of the content asset may comprise a modified version of the content asset and/or another version of the content asset, such as a version that has been processed, decrypted, encrypted, transcoded, packaged, re-coded, augmented, re-indexed, and/or re-formatted, as examples. The digital marker may comprise an image or a pattern. The digital marker may be opaque, transparent, or semi-transparent. The digital marker may comprise data, such as algorithmically-derived data and/or data associated with metadata associated with the content asset. The digital marker may overlay at least a portion of one or more frames of the content asset.

The digital marker may comprise code embedded in a codec of the content asset, such as in a codec of the one or more frames of the content asset. For example, the digital marker may be embedded when the content asset is compressed. The digital marker may be invisible. The digital marker may be indelible from the one or more frames of the content asset.

The digital marker may be generated using at least the unique identifier. The unique identifier may be provided to an entity that generates the digital marker by the license server. The content distributor may generate the version of the content asset comprising the digital marker. The digital marker may be generated using technology provided by a third-party vendor, such as a vendor having a proprietary digital marking technology. The digital marker may be generated by a computing device, such as by a client-side application or a system-on-chip (SoC).

The version of the content asset may comprise a plurality of frames. The digital marker may be embedded in one or more of the frames. Every frame may comprise the digital marker or a portion of the digital marker. A portion of the frames may comprise the digital marker or a portion of the digital marker. The digital marker may be blended into a stream of the content asset. The digital marker may be indelible. For example, the digital marker may be inextricable from the frames of the content asset without the use of specialized technology for removing digital markers. The digital marker may not be destroyed or removed from the frames of the content asset. As an example, if the content asset is transformed (i.e., converted to analog or digital, frame size is changed, effects are added), the digital marker may not be altered and may remain intact. As an example, if the content asset is recorded on another device, the digital marker may not be altered and may remain intact.

The digital marker may comprise a payload. The payload may comprise metadata. The metadata may comprise an indication of the unique identifier of the user device. The metadata may comprise an indication of the content distributor. The metadata may comprise an indication of the digital marking technology used to generate the digital marker. The payload may comprise a data size, such as a data size of 4 bytes, 6 bytes, 8 bytes, or 10 bytes.

A transaction and/or a record entry may be generated. For example, the transaction and/or record entry may be generated based on receiving the request for the content asset and/or determining that the user device is authorized to access the content asset. The transaction and/or record entry may be configured for a distributed ledger with authenticated and/or connected entries, such as a blockchain. The distributed ledger may comprise a permissionless distributed ledger. A permissionless distributed ledger may be accessed by the public. For example, authorization may not be necessary to download and generate new records on a permissionless distributed ledger. The distributed ledger may comprise a permissioned distributed ledger. Access to the permissioned distributed ledger may be limited to authorized entities, such as piracy deterrence groups, digital content vendors, law enforcement agencies, and/or content distributors. The distributed ledger may comprise a permissioned distributed ledger that is a sidechain of another distributed ledger. The distributed ledger may use a Sawtooth framework.

The distributed ledger may be associated with a content distributor, such as the distributor of the requested content asset. For example, the distributed leger may be controlled or maintained by the content distributor. Each content distributor may maintain a distributed ledger comprising records of accessed content assets associated with, distributed by, owned by, or provided by the content distributor

The transaction and/or record entry may comprise an indication that the user device requested the content asset. The transaction and/or record entry may comprise information from the request for content asset, such as the unique identifier of the user device or an indication of the content asset. The transaction and/or record entry may comprise a stream identifier (ID). The stream ID may be generated by the content distributor. The stream ID may comprise information that may be used to determine that the content asset has been received or accessed. The stream ID may comprise an indication of under what conditions the content may be accessed.

The transaction and/or record entry may comprise a source ID. The source ID may comprise an indication of a storage location of the content asset, such as a universal resource locator (URL), file name, or an address on a server. The source ID may comprise a timestamp. The timestamp may indicate a date or time at which the content asset was generated. The timestamp may be generated by a distributor, owner, or creator of the content. At least a portion of the transaction and/or record entry may be encrypted, such as using a key associated with the computing device that generates the transaction and/or record entry. At least a portion of the transaction and/or record entry may not be encrypted, such as to facilitate access to the data stored in the transaction and/or record entry.

The transaction and/or record entry may be devoid of personal identifying information (PII). For example, the transaction may not comprise an indication of a user associated with the user device, such as a name of the user, account number of the user, or location of the user. The absence of PII may enable a plurality of entities, such as piracy deterrence agencies, digital marker technology vendors, and content distributors to share and access the distributed ledger. The absence of PII may preclude the need to encrypt the transaction and/or record entry, such as to obscure the PII for data privacy or data security.

The generated transaction and/or record entry may be sent to another computing device. The transaction and/or record entry may be sent via a miner application. The miner application may be configured to receive a plurality of transactions and/or record entries. The miner application may be configured to validate the transactions and/or record entries. Validating the transactions and/or record entries may comprise determining that the transactions and/or record entries were generated by a device authorized to access or modify the distributed ledger, such as a device associated with the content distributor.

Based on validation of the transactions and/or record entries, the miner application may be configured to combine the transactions and/or record entries, such as in a block or a record of the distributed ledger. The block or record may comprise a plurality of transactions and/or record entries. The transactions and/or record entries may be combined based on a method selected to facilitate efficient location of the transactions and/or record entries. As an example, a transaction and/or record entry may be combined with other transactions and/or record entries that were generated at a same time or within a same period of time. The transaction and/or record entry may be combined with other transactions and/or record entries indicative of a content asset request sent or received at a same time or within a same period of time. The transaction and/or record entry may be combined with other transactions and/or record entries comprising indications of the same content asset. The transaction and/or record entry may be combined with other transactions and/or record entries comprising indications of the same user device, such as the same unique identifier.

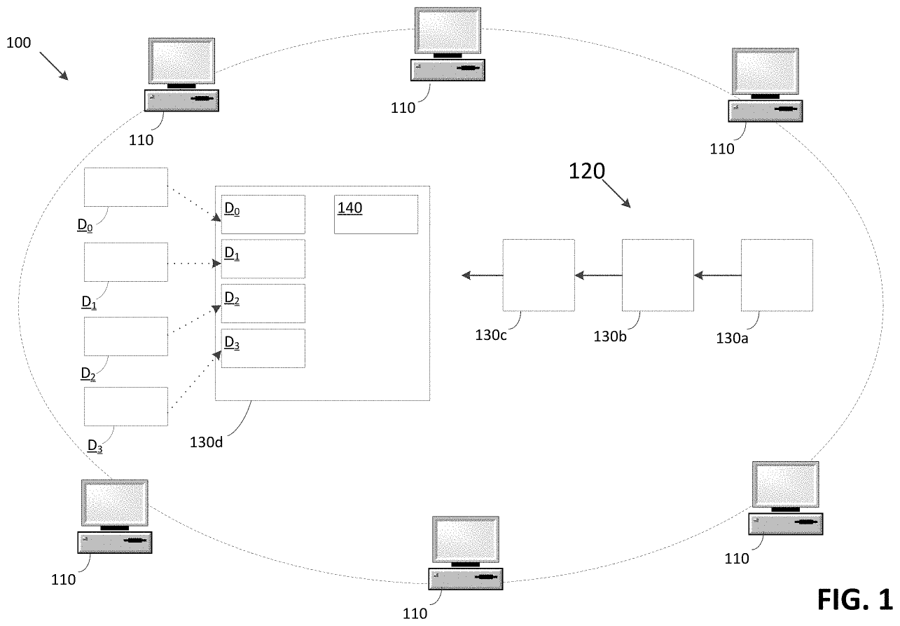

The block and/or record may comprise an indication of a previous block and/or record in the distributed ledger. The miner application may be configured to store the block and/or record to the distributed ledger. Storing the block and/or record to the distributed ledger may comprise sending the block and/or record to nodes of the distributed ledger. Instances of the distributed ledger across nodes of the distributed ledger may be kept in synch, such as by sending an indication of a change to the distributed ledger or an updated version of the distributed ledger. An example distributed ledger is described below in reference to FIGS. 1-3.

Digital content sourced from many servers, data sources, and/or businesses may be monitored. The digital content may be randomly monitored. A copy of digital content, such as a potentially pirated copy, may comprise a digital marker. A pirated copy may comprise a copy of content that was made, accessed, and/or sent without the authorization of a rights holder of the content. A copy may comprise a version of content that was extracted from one device to another, such as using a high-definition multimedia interface (HDMI). The copy may comprise a version that was extracted while the digital content was sent from a content distributor to a user device or display device (e.g., client device, router, gateway device, set top box, etc.). The copy may be stored on a server. The copy may comprise a transcoded version of the content. The copy may comprise a version of content stored on another device or memory. The copy may comprise a version of the content converted to a different frame size.

To determine that the copy of the content comprises the digital marker, digital marker extraction methods may be used to extract metadata. The digital extraction method used may be based on the type of digital marker. For example, a proprietary digital extraction method of a digital marker vendor may be used to extract metadata from a digital marker generated using technology of the digital marker vendor. If the type of digital marker or the extraction method is not known, various extraction methods may be performed until one results in extraction of the metadata.

From the extracted metadata, the unique identifier may be determined. The distributed ledger may be examined. The transaction and/or record entry comprising the indication of the unique identifier may be located. Using the transaction and/or record entry, a determination may be made that the user device associated with the unique identifier requested and/or accessed the content.

The unique identifier and/or an indication of the user device may be added to a blacklist. The blacklist may comprise a database of unique identifiers and/or indications of user devices. The blacklist may comprise a record of user devices that are no longer authorized to access content, as a result of content piracy. Based on the blacklist, requests from the user devices identified in the blacklist for content may be denied.

Based on the blacklist, content streamed to a user device may be terminated. For example, during playing a segment of a content asset, a DRM client on the user device may send a request for a next segment of the content. The DRM client may send the request based on a determination that a bitrate, bandwidth, and/or resolution of the content asset should be adjusted based on network bandwidth and/or congestion (e.g., such as with adaptive streaming, at the source level, etc.). A determination may be made that the user device is associated with piracy. An indication of the user device and/or a unique identifier associated with the user device may be added to the blacklist. Based on the determination of piracy or based on the update to the blacklist, the adjusted segment of the content asset may not be sent to the user device and permission for content may be denied to the user device.

Video may be segmented into 1-2 second chunks of play time. A separate call request may go out from the user device at 1-2 second increments for subsequent chunks. However, other chunk sizes are possible, such as 6 second chunks. A determination may be made that the user device is associated with piracy. An indication of the user device and/or a unique identifier associated with the user device may be added to the blacklist. Based on the determination of piracy or based on the update to the blacklist, subsequently requested chunks of the content asset may not be sent to the user device and permission for content may be denied to the user device.

The distributed ledger may be used to verify a source of pirated content for evidentiary purposes. The transaction and/or record entry may be used as evidence that the content was requested or accessed by the user device associated with the unique identifier. The transaction and/or record entry may be used as legal evidence, such as if legal action were taken against the user or taken by the user, such as against the content distributor.

The transaction and/or record entry may function to provide legitimacy to the information associated with the access to content. For example, the transaction and/or record entry may provide legitimacy by being irrefutable and immutable. In order to terminate the providing of content to an entity, it may be necessary to legally prove that the entity is the source of piracy.

The use of the distributed ledger may facilitate coordination between various parties involved in the digital content industry, such as digital marker technology vendors, piracy monitoring companies, and content distributors. The parties may not be co-located, yet they may all have access to the distributed ledger. The distributed ledger may not comprise personally identifying information (PII). As a result of the absence of PII from the distributed ledger, the parties may openly share and access the distributed ledger and the information stored in distributed ledger. For example, the absence of PII may preclude the need to encrypt of all or portions of the distributed ledger. The absence of PII may result in the distributed ledger comprising a public distributed ledger or a permissioned distributed ledger, such as instead of a private distributed ledger. Allowing various parties to access the distributed ledger may automate workflows between content creation, content distribution, digital marker creation, digital marker extraction, piracy source identification, piracy prevention, and law enforcement. Allowing various parties to access the distributed ledger may increase collaboration for developing efficient tools and optimal solutions for deterring digital content piracy.

FIG. 1 shows an example distributed system. The distributed system may comprise a network 100 of nodes 110. A node 110 may comprise a computing device, a central processing unit, a graphical processing unit, a field programmable gate array, or an application specific integrated circuit. A node 110 may comprise a content distribution device, such as a cable modem, set-top box, lap top, smart phone, tablet, a portable digital assistant, a smart television, wearable computing device, mobile computing device, or any computing device in communication with a content distribution network.

The network 100 of nodes 110 may comprise a decentralized database. The decentralized database may not have a central administrator or centralized storage. For example, each node 110 in the network 100 may store a copy of a collection of data, such as a distributed ledger. A distributed ledger may comprise recorded entries, such as transactions. The data may be replicated, shared, or synchronized across the nodes 110. The decentralized database may be continually reconciled, such as to reflect changes to the collection of data. The nodes 110 may continually or periodically download the most recent version of the collection of data. Based on a node 110 joining the network 100, the node 110 may automatically download the collection of data.

A decentralized database, may comprise a distributed ledger, such as a blockchain 120. The blockchain 120 may comprise one or more records, such as blocks 130 in which data is recorded. The blocks 130 may comprise entries or transactions indicating unique identifiers of user devices and content assets requested, accessed, or received by one or more of the user devices. The blocks 130 in the blockchain 120 may function as a mechanism to organize the data in the blockchain 120. For example, the blocks 130 may be linked in a sequence determined by a relationship of the data in the blocks 130, such as the chronology in which the data is recorded or validated. The blocks 130 may be linked to deter retroactive modification of data in the blockchain 120.

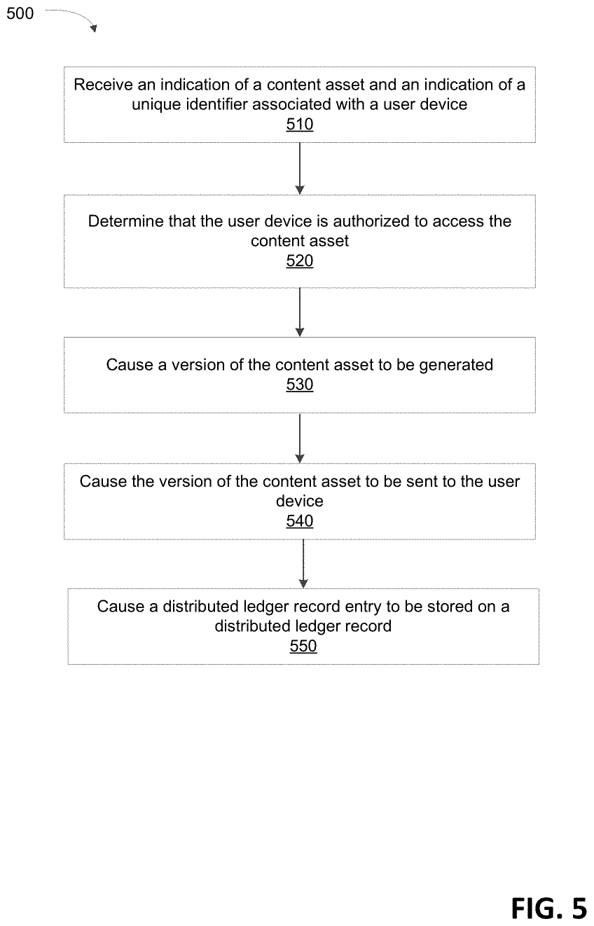

The nodes 110 in the network 100 may build the blockchain 120, such as by adding blocks 130 to the blockchain 120. The nodes 110 may execute several operations to build the blockchain 120. For example, based on new data D₀, D₁, D₂, D₃ being received by the network 100, the nodes 110 may validate the new data D₀, D₁, D₂, D₃. As an example, if the new data D₀, D₁, D₂, D₃ comprises transactions, the nodes 110 may validate, verify, or authenticate the identity of the parties to the transaction. The one or more transactions will be discussed in more detail in reference to FIGS. 5 & 6 below. A transaction may comprise a public key of a party to the transaction and a digital signature of the party to the transaction. The digital signature may comprise the hash of transaction data, such as with a cryptographic hash function. The digital signature may comprise a hash of transaction data encrypted with a private key corresponding to the public key. Examples of hash functions include MD4, MD5, SHA-1, SHA-256, SHA-512, and SHA-3. The digital signature may be validated by the nodes 110, such as by decrypting the digital signature with the public key.

The nodes 110 may collate the new data D₀, D₁, D₂, D₃ into a new block 130d. The nodes 110 may record one or more data entries Do in a new block 130d. The nodes 110 may execute an operation to add the new block 130d or a plurality of new blocks to the blockchain 120. For example, if the data in the blocks 130 is related chronologically, such as where the first block 130a in the chain records older data than the data of subsequent blocks 130b, 130c, the nodes 110 may perform a timestamp function to log the sequence in which blocks 130 are added to the blockchain 120. The nodes 110 may append a hash of the previous block 130c to the new block 130d. The nodes 110 may insert an output of the previous block 130 in an input of the new block 130d. The chaining of the blocks, such as through iterative functions, may deter retroactive modification of data in a block 130 as the modification would require new functions to be performed for all of the subsequent blocks 130 in the blockchain 120.

Based on the new block 130d being added to the blockchain 120, the nodes 110 may communicate the new block 130d to the network 100. The nodes 110 may indicate their acceptance of the new block 130d to the blockchain 120 by working off the block 130d to add a subsequent block to the blockchain 120. If more than one version of the blockchain 120 exists, the nodes 110 may attempt to work off the longest blockchain 120. The longest blockchain 120 may be determined by an algorithm for scoring the blockchain 120. For example, a blockchain 120 may be assigned a score based on the computational work required to generate the blockchain 120. A node 110 may communicate the longest blockchain 120 that the node 110 has observed to the network 100, such as with a gossip protocol.

The network 100 may have self-correcting mechanisms, such as to address discrepancies between nodes 110 in the network 100. For example, if there is a fork in a blockchain 120, a node 110 working off one branch of the blockchain 120 may switch to a second branch of the blockchain 120, if the second branch becomes longer than the first branch. As an, example, if a node 110 does not receive a block 130b, the node 110 may request the block 130b based on the node 110 receiving the next block 130c and determines that the node 110 did not receive the previous block 130b.

One or more nodes 110 in the network 100 may not participate in building the blockchain 120. The operations that the nodes 110 in the network 100 may perform associated with to the blockchain may not be limited to building the blockchain 120. As an example, one or more nodes 110 may monitor the blockchain 120 for particular transactions. For example, the nodes 110 may monitor the blockchain 120 for transactions that comprise an identifier associated with a party.

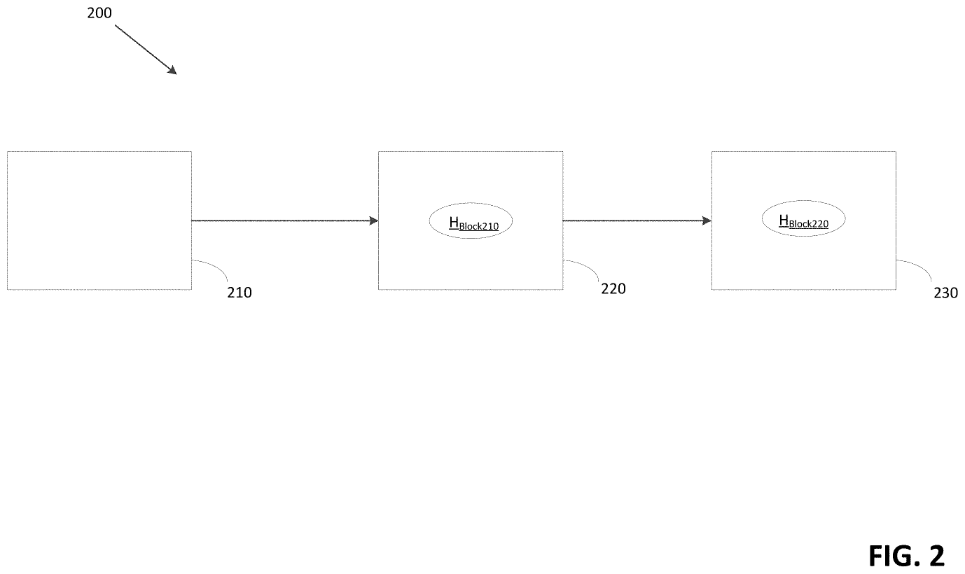

FIG. 2 shows an example distributed ledger architecture. A distributed ledger may comprise a blockchain 200 in which one or more transactions are recorded in blocks 210, 220, 230. The one or more transactions will be discussed in more detail in reference to FIGS. 5 & 6 below. The blocks 210, 220, 230 may be linked in a sequence that represents the chronology of the execution, validation, or recording of the transactions. For example, the blockchain 200 may comprise a genesis block 210 that records the earliest transaction in the blockchain 200 and comprises the first block 210 in the blockchain 200. Each block 220, 230 following the genesis block 210 may record one or more transactions that were executed or validated subsequent to the transactions of the preceding block 210, 220, 230 in the blockchain 200. The transactions may indicate content assets and unique identifiers of user devices that requested, accessed, or received one or more of the content assets. Each block 210, 220, 230 may record transactions that occurred prior to the transactions of the subsequent block 220, 230 in the blockchain 200. As an example, the block 230 may record transactions that occurred after the transactions recorded in the block 220. A new transaction may be recorded in a new block. The new transaction may indicate a content asset and a unique identifier of a user device that requested, accessed, or received the content asset. The new block may be appended to the last block 230 in the blockchain 200. Although the example blockchain 200 is shown as comprising three blocks 210, 220, 230, the blockchain 200 may comprise less than three blocks or more than three blocks. The blocks 210, 220, 230 may record transactions as hashes of the transactions. The blocks 210, 220, 230 may be connected, such as to establish the chronological order of the transactions in the blockchain 200. Each block 210, 220, 230 may comprise an indication of one or more preceding blocks 210, 220, 230 in the blockchain 200. For example, a block 210, 220, 230 may comprise an indication of a hash H_{Block210}, H_{Block 220} of the transactions in one or more preceding blocks 210, 220, 230. The linking of the blocks 210, 220, 230 may deter modification of a block 210, 220, 230 or transaction in the blockchain 200. For example, tampering with a block 210, 220, 230 may require modifying transactions in preceding blocks 210, 220, 230 of the blockchain 200.

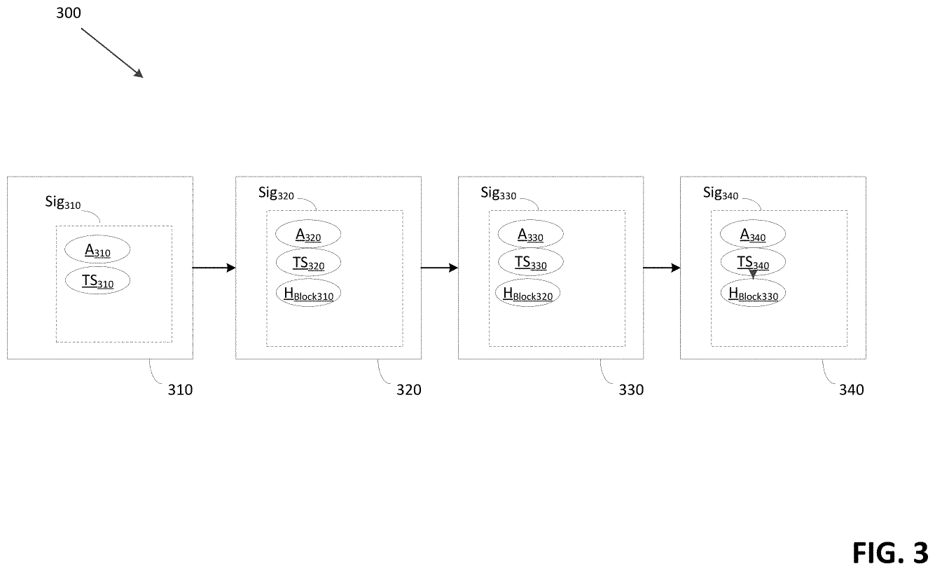

FIG. 3 shows an example distributed ledger architecture. The system may comprise a distributed ledger 300. The distributed ledger may comprise a blockchain. The distributed ledger 300 may be associated with an entity, such as a service provider, content distributor, content distributor, content license manager, or content creator.

The distributed ledger 300 may comprise a plurality of blocks 310, 320, 330, 340. Each block 310, 320, 330, 340 may comprise one or more distributed ledger entries. Each block 310, 320, 330, 340 may comprise an indication of one or more content assets requested or accessed and a unique identifier associated with a user device that requested or accessed the one or more content assets (A₃₁₀, A₃₂₀, A₃₃₀, A₃₄₀).

Each block 310, 320, 330, 340 may comprise a timestamp (TS₃₁₀, TS₃₂₀, TS₃₃₀, TS₃₄₀). The timestamp (TS₃₁₀, TS₃₂₀, TS₃₃₀, TS₃₄₀) may indicate a date or time at which the block 310, 320, 330, 340 was generated. The inclusion of the timestamps (TS₃₁₀, TS₃₂₀, TS₃₃₀, TS₃₄₀) may link the blocks 310, 320, 330, 340. Each block generated after a genesis block 320, 330, 340 may comprise a hash (H_{Block310}, H_{Block320}, H_{Block330}) of the previous block (H_{Block310}, H_{Block320}, H_{Block330}) in the distributed ledger 300. The inclusion of the hash of the previous block (H_{Block310}, H_{Block320}, H_{Block330}) in the distributed ledger 300 may link the blocks 310, 320, 330, 340. The inclusion of the hash of the previous blocks (H_{Block310}, H_{Block320}, H_{Block330}) in the distributed ledger 300 may comprise an iterative chain of hash functions. The linking of the blocks 310, 320, 330, 340 may deter unauthorized tampering or breaching of the distributed ledger 300. For example, tampering with a block 310, such as retroactively modifying the block 310, may require modification of the subsequent blocks 320, 330, 340. The computing power or labor to tamper or breach the distributed ledger 300 may deter targeting of the distributed ledger 300 by an unauthorized entity.

Each block 310, 320, 330, 340 may comprise a signature (Sig₃₁₀, Sig₃₂₀, Sig₃₃₀, Sig₃₄₀). The signature (Sig₃₁₀, Sig₃₂₀, Sig₃₃₀, Sig₃₄₀) may comprise an encryption with a key of a device that manages the distributed ledger 300, such as a private key of the device. The signature (Sig₃₁₀, Sig₃₂₀, Sig₃₃₀, Sig₃₄₀) may comprise an encryption of one or more of the content asset and/or device identifiers (A₃₁₀, A₃₂₀, A₃₃₀, A₃₄₀), the hash of the key, the timestamp (TS₃₁₀, TS₃₂₀, TS₃₃₀, TS₃₄₀) and the hash of the previous block (H_{Block310}, H_{Block320}, H_{Block330}). The signature (Sig₃₁₀, Sig₃₂₀, Sig₃₃₀, Sig₃₄₀) may deter unauthorized tampering with the distributed ledger 300. The private key used to sign may be necessary to generate or retroactively modify a block or entry of the distributed ledger 300. Only the managing device or another entity or device having the private key may alter or add to the distributed ledger 300.

At least a portion of the data in blocks 310, 320, 330, 340 may not be encrypted. The data may not be encrypted in order for the data to be accessible to a plurality of entities. For example, the data may not be encrypted so that the data may be accessed by technology groups involved in the development of digital marker detection and piracy source identification, digital marker technology vendors, and content distributions. The data may not be encrypted to facilitate ease of access and sharing of the data, such as in order to foster cooperation between the technology groups and vendors. The data in blocks 310, 320, 330, 340 may comprise data associated with access to digital content, such as indications of content and indications of user devices requesting the content. The data may not comprise personal identifying information (PII), such as information associated with users of the user devices. Therefore, the absence of PII may preclude encryption and/or other security measures with respect to the data.

The distributed ledger 300 may comprise a genesis block 310. The genesis block 310 may comprise the first block of the distributed ledger 300. The genesis block 310 may comprise the oldest block or the first block generated of the distributed ledger 300. The device configured to manage the distributed ledger 300 may generated the genesis block 310. The managing device may send an indication of the genesis block 310 to other managing devices. Based on receiving the indication of the genesis block 310, the managing device may store synchronized versions of the distributed ledger 300. One or more of the managing devices may generate the subsequent blocks 320, 330, 340 of the distributed ledger 300.

The distributed ledger 300 may comprise a component of a distributed ledger. The distributed ledger 300 may comprise a branch of another blockchain, such as a general blockchain. The general blockchain may comprise a plurality of branches. Each of the plurality of branches may comprise a blockchain or another plurality of blockchains. The general blockchain may comprise a plurality of blockchains. For example, each of the plurality of blockchains may be associated with a different content distributor. Each of the plurality of blockchains may comprise a register of content associated with the respective content distributor that was requested or accessed.

The distributed ledger 300 may be stored at a distributed network. The distributed ledger 300 may be stored across nodes, such as the nodes 110 of FIG. 1, in a distributed network, such as the network 100 of FIG. 1. The nodes may comprise computing devices. The nodes may comprise systems that perform operations associated with one or more of content creation, content distribution, digital marker creation, digital marker extraction, piracy source identification, piracy prevention, and law enforcement.

The distributed ledger 300 may be updated. Updating the distributed ledger 300 may comprise generating a distributed ledger entry. Updating the distributed ledger 300 may comprise sending a distributed ledger entry to the distributed ledger 300 or a network. Updating the distributed ledger may comprise recording the distributed ledger entry in a block 310, 320, 330, 340 of the distributed ledger 300. Updating the blockchain may comprise generating a block 310, 320, 330, 340 of the distributed ledger 300. The distributed ledger 300 may be updated by a computing device or an application.

The distributed ledger 300 may be updated using a custom software library. Updating the distributed ledger 300 may comprise performing underlying blockchain integration, such as adding a new block to the blockchain.

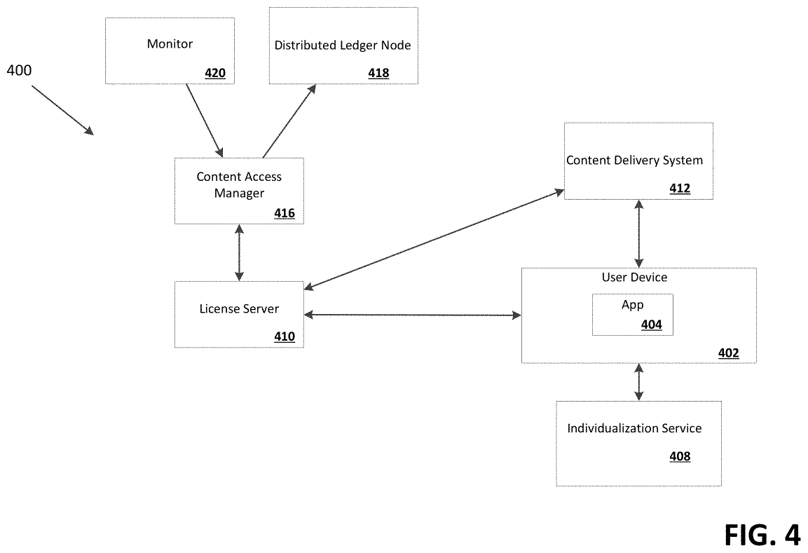

FIG. 4 shows an example system environment 400. The system environment 400 may comprise a user device 402, a license server 410, a content delivery system 412, a content access manager 416, a distributed ledger node 418, and/or a monitor 420. A content distributor may control the license server 410, the content delivery system 412, and/or the content access manager 416.

The user device 402 may comprise at least one of a tablet device, a mobile telephone, a laptop computer, a portable digital assistant, a set-top box, or a smart television, as examples. The user device 402 may comprise an application 404. The content distributor may provide the application 404. The application 404 may facilitate content delivery to the user device 402. The application 404 may comprise a digital rights management (DRM) client. The DRM client may comprise a secure memory.

A unique identifier associated with the user device 402 may be generated. The unique identifier may comprise a series of alphanumeric characters. The unique identifier may comprise binary data. The unique identifier may be different from other identifiers associated with other devices. The unique identifier may be associated with the application 404 on the user device. The unique identifier may be stored on the user device 402, such as in the secure memory of the application 404.

The unique identifier may be stored in a database of unique identifiers. The database may be devoid of personal identifying information (PII). Based on the database not comprising PII, no data security or less data security measures may be needed. The database may comprise PII. For example, the database may comprise an indication of users associated with the user devices. The unique identifiers of the user devices may be mapped to indications of the users, such as names, accounts, contact information, or geographic information of the users. Based on the database comprising PII, the manager of the database, such as the content delivery system 412, may use data security methods to protect the PII. The data security methods may comprise software-based data protection and/or hardware-based data protection. The data security methods may comprise encryption, backups, data masking, and/or data erasure, as examples.

The user device 402 may request a content asset. The content asset may comprise digital content, such as a video, a game, music, or a book, as examples. The application 404 may send the request to a license server 410. The request may comprise an indication of the unique identifier associated with the user device 402 and an indication of the content asset.

The license server 410 may receive the request. Based on the request, the license server 410 may send an indication of the content asset and/or the unique identifier to a content access manager 416. The content access manager 416 may be configured to determine that a device is authorized to access a content asset. For example, the content access manager 416 may determine that the user device 402 is authorized based on a determination that the unique identifier is not on a blacklist of banned devices or users. As an example, the content access manager 416 may determine that the user device 402 is authorized based on a determination that unique identifier is associated with the user device 402 or the application 404 associated with the content delivery system 412. The content access manager 416 may determine that the unique identifier is associated with a customer or subscriber of the content delivery system 412. The content access manager 416 may send an indication that the user device is authorized to access the content asset to the license server 410. The content access manager 416 may cause a distributed ledger record entry to be stored in a distributed ledger record of a distributed ledger. The distributed ledger may be similar to any of distributed ledgers 120 in FIG. 1, 200 in FIG. 2, or 300 in FIG. 3. The distributed ledger may be stored on one or more distributed ledger nodes 418. The nodes 418 may be similar to the nodes 110 in FIG. 1. The distributed ledger may comprise a plurality of records. Each record may comprise a plurality of entries. Each of the distributed ledger entries may comprise an indication of a unique identifier of a user device and/or an indication of a content asset requested or accessed by the user device. The distributed ledger, the distributed ledger record, and the distributed ledger entry may be devoid of personal identifying information (PII), such as names of users associated with user devices, contact information of the users, or billing information of the users.

The distributed ledger record entry may comprise an indication of the unique identifier. The distributed ledger record entry may comprise an indication of the content asset. The distributed ledger record entry may comprise an indication that the content asset was requested, accessed, and/or sent to the user device 402. The distributed ledger record entry may comprise an indication of a source of the content asset, such as an indication of a content distributor, such as the content delivery system 412. The distributed ledger record entry may comprise an indication of a storage location from which the content asset is sent or copied. The distributed ledger record entry may comprise an indication of a time that the content asset was requested, accessed, or sent to the user device 402.

The distributed ledger may comprise a blockchain. The distributed ledger record entry may comprise a blockchain transaction. The distributed ledger record may comprise a blockchain block. The content access manager 416 may be configured to cause the distributed ledger record entry to be stored on the distributed ledger by causing the transaction to be stored on the block of the blockchain. The distributed ledger may be stored on one or more distributed ledger nodes 418. Based on the determination that the user device 402 is authorized to access the content asset, the content access manager 416 may cause the distributed ledger record to be stored on the distributed ledger. The content access manager 416 may be configured to cause the distributed ledger record entry to be stored on the distributed ledger by sending the distributed ledger record entry to at least one of the nodes 418. Based on the determination that the user device 402 is authorized to access the content asset, the license server 410 may send an indication of the unique identifier and the content asset to a content delivery system 412. The content delivery system 412 may comprise a digital rights management (DRM) packager. The DRM packager may comprise one or more computing devices that are configured to encrypt a digital content asset. The DRM packager may comprise one or more computing devices that are configured to generate a version of a digital content asset that comprises a digital marker, such as a watermark. The content delivery system 412 may comprise one or more content delivery servers or networks. The content delivery system 412 may comprise digital marker functionality, such as a digital marker session manager on one or more of the content delivery system servers.

The license server 410 may send, to the content delivery system 412, an indication that the user device 402 is authorized to access the content asset. In response to the indication from the license server 410, the content delivery system 412 may cause a version of the content asset to be generated. The version of the content asset may comprise a copy of the content asset and/or another version of the content asset. The version of the content asset may comprise a modified version of the content asset and/or another version of the content asset, such as a version that has been processed, decrypted, encrypted, transcoded, packaged, re-coded, augmented, re-indexed, and/or re-formatted, as examples. Alternatively or additionally, the user device 402 may send the request for the content asset to the content delivery system 412 and the content delivery system 412 may cause the version to be generated in response to the request.

The version of the content asset may comprise a digital marker, such as a watermark or a digital fingerprint. The digital marker may comprise an image or a pattern. The digital marker may be opaque, transparent, or semi-transparent. The digital marker may comprise data, such as algorithmically-derived data and/or data associated with metadata associated with the content asset. The metadata may comprise the unique identifier of the user device 402. The digital marker may overlay at least a portion of one or more frames of the content asset.

The digital marker may comprise code embedded in a codec of the content asset, such as in a codec of the one or more frames of the content asset. For example, the digital marker may be embedded when the content asset is compressed. The digital marker may be invisible.

The digital marker may be indelibly embedded in one or more frames of the content asset. For example, the indelibly embedded digital marker may be configured to remain embedded in one or more frames of the content asset if the content asset is copied, transformed (e.g., converted to analog or digital, frame size is changed, effects are added), or moved from one storage medium to another storage medium.

The content delivery system 412 may cause the version of the content asset to be generated by generating the version of the content using a server of the content delivery system 412. A digital marker session manager may be embedded in functionality of the content delivery network server. The content delivery system 412 may cause the version of the content asset to be generated by causing a packager of the content delivery system 412 to generate the version. The packager may comprise a digital marker embedder and the packager may generate the version using the digital marker embedder. The digital marker session manager and/or the digital marker embedder may comprise technology of a third-party vendor. The technology may comprise a proprietary digital marker or watermarking technology.

The content delivery system 412 may send the version of the content asset to the user device 402, such as by streaming the version of the content asset or by storing the version to a storage accessible to the user device 402. The content delivery system 412 may send the version based on receiving, from the license server 410, an indication that the user device 402 is authorized to access the content asset.

Pirated content may comprise a version of a content asset that was made, accessed, and/or sent without the authorization of a rights holder of the content. If potentially pirated content is determined, the unique identifier may be determined from the digital marker of the potentially pirated content. For example, a digital marker extraction technique may be used to extract the unique identifier from a digital marker. The digital extraction method used may be based on the type of digital marker. For example, a proprietary digital extraction method of a digital marker vendor may be used to extract metadata from a digital marker generated using technology of the digital marker vendor. If the type of digital marker or the extraction method is not known, various extraction methods may be performed until one results in extraction of the metadata.

A monitor 420 may determine that content is potentially pirated. The monitor 420 may comprise a user or a computing device associated with a forensics services provider or piracy monitoring agency. The monitor 420 may determine that the content is potentially pirated based on the content asset, based on a device that is sourcing the content, and/or based on a network used to share the content. The monitor 420 may determine that the potentially pirated content is associated with the content delivery system 412. The monitor 420 may access the distributed ledger associated with the content delivery system 412 and/or similar systems. The monitor 420 may search the distributed ledger for a transaction comprising the unique identifier. The monitor 420 may locate the transaction comprising the unique identifier. The monitor 420 may determine that the transaction comprises an indication of a content asset corresponding to the potentially pirated content. The monitor 420 may determine that the potentially pirated version of the content was pirated. The monitor 420 may determine that the device and/or user associated with the unique identifier was a source of the pirated content.

Based on the determination that the device associated with the unique identifier was a source of the pirated content, the monitor 420 and/or another device in FIG. 4 may cause the unique identifier to be added to a blacklist. The blacklist may comprise a database of devices that are associated with piracy. Based on the blacklist, a device that is identified in the blacklist may not be permitted to access content. Based on the blacklist, requests from the devices identified in the blacklist for content may be denied.

Based on the blacklist, the sending of content to one or more of the devices may be interrupted or terminated. For example, streaming of a content asset to a user device may be interrupted or terminated based on a determination that the blacklist comprises the unique identifier and/or another indication of the user device. As an example, a content asset may comprise a plurality of chunks. The chunks may comprise portions of the content asset. The chunks may comprise portions of the content asset associated with period of play time of the content asset, such as 1 second chunks, 2 second chunks, or 6 second chunks. The license server 412 may receive a request from the user device 402 for access to the content asset and/or for a first portion of the chunks. Based on the request, the license server 412 may send an indication of the unique identifier of the user device 402 and/or an indication of the content asset to the content access manager 416. The content access manager 416 may determine that the blacklist does not comprise an indication of the unique identifier. The content access manager 416 may send the license server 412 an indication that the user device 402 is authorized to access the content asset and/or the first portion of the chunks. Based on the indication, the license server 412 may send, to the content delivery system 412, an indication to send the first portion of the chunks to the user device 402. The content delivery system 412 may send, to the user device 402, the first portion of the chunks.

The license server 412 may receive a request for a second portion of the chunks from the user device 402. Based on the request or independent of receiving a request, the license server 412 may send an indication of the user device to the content access manager 416 and/or a request to determine whether the blacklist comprises the unique identifier of the user device 402. The content access manager 416 may determine that the blacklist does not comprise the unique identifier of the user device 402. Based on the determination that the blacklist does not comprise the unique identifier of the user device 402, the content access manager 416 may send, to the license server 410, an indication that the user device 402 is authorized to access the content asset and/or the second portion of the chunks. Based on the indication, the license server may send, to the content delivery system 412, an indication to send the second portion of the chunks to the user device. Based on the indication, the content delivery system 412 may send the second portion of the chunks to the user device.

After the sending of the first portion of the chunks, the unique identifier of the user device 402 may have been added to the blacklist, such as based on a determination that the user device 402 was a source of pirated content. Based on a determination that the blacklist comprises the unique identifier and/or another indication of the user device 402, a determination may be made not to send a second portion of the plurality of chunks to the user device 402. For example, the content access manager 416 may determine that the blacklist comprises the unique identifier of the user device 402. Based on the determination that the blacklist comprises the unique identifier of the user device 402, the content access manager 416 may send, to the license server, an indication that the user device 402 is not authorized to access the content asset and/or the second portion of the chunks. Based on the indication, the license server 410 may send, to the content delivery system 412, an indication not to send the second portion and/or a subsequent portion of the chunks to the user device.

The blacklist may be used as a defense against the termination or interruption of content sent to a user device. For example, if the user device requested access to a content asset and payment was provided for access to the content asset, the content distributor may not legally restrict access to the content asset without a defense. The blacklist may be used to prove that the user device was involved in piracy. The user device's involvement in piracy may comprise the defense.

Based on the determination that the device associated with the unique identifier was a source of the pirated content, legal action may be taken against a user of the device associated with the unique identifier. The blacklist and/or the distributed ledger may not comprise personal identifying information (PII), such as device unique identifiers mapped to identities of users. The content distributor, such as the content delivery system 412, may have information associated with users, such as identities of users of the user devices. The content distributor may take legal action against the user based on having access to a database of user identities mapped to device unique identifiers.

FIG. 5 shows an example method 500. At step 510, an indication of a content asset and an indication of a unique identifier associated with a user device may be received by a computing device. The indication of the content asset and the indication of the unique identifier may be received from the user device. For example, the license server 410 in FIG. 4 may receive an indication of a content asset and an indication of a unique identifier associated with the user device 402 in FIG. 4 from the user device 402 in FIG. 4. The content asset may comprise at least one of a video, music, a game, or a book, as examples. The user device may comprise at least one of a tablet device, a mobile telephone, a laptop computer, a portable digital assistant, a set-top box, or a smart television, as examples. The unique identifier may comprise a series of alphanumeric characters. The unique identifier may comprise a binary number. The unique identifier may be different from unique identifiers associated with other devices. The unique identifier may be used to distinguish the user device from other devices. The unique identifier may be associated with a DRM client of the user device.

At step 520, a determination may be made that the user device is authorized to access the content asset based on at least the receiving the indication of the content asset and the unique identifier. For example, the license server 410 may send, to the content access manager 416 in FIG. 4, an indication of the request for the content asset. The license server 410 may send an indication of the content asset and/or an indication of the unique identifier of the device to the content access manager 416. The content access manager 416 may determine, based on the content asset and/or the unique identifier of the device, that the user device 402 in FIG. 4 is authorized to access the content asset. Determining that the user device is authorized to access the content asset may comprise determining that a blacklist of devices that are not authorized to access content does not comprise an indication of the user device. For example, the content access manager 416 in FIG. 4 may determine that a blacklist of devices that are not authorized to access content does not comprise an indication of the user device 402 in FIG. 4. Determining that the user device is authorized to access the content asset may be based on various other factors, including but not limited to a geographic location of the user device, a content service purchased by a user of the user device, hardware of the user device, software of the user device, or a content security protocol of the user device.

At step 530, a version of the content asset may be caused to be generated based on at least the determining that the user device is authorized to access the content asset. The version of the content asset may comprise a copy of the content asset and/or another version of the content asset. The version of the content asset may comprise a modified version of the content asset and/or another version of the content asset, such as a version that has been processed, decrypted, encrypted, transcoded, packaged, re-coded, augmented, re-indexed, and/or re-formatted, as examples.

The license server 410 in FIG. 4 may send, to the content delivery system 412, an indication that the user device 402 in FIG. 4 is authorized to access the content asset. In response, the content delivery system 412 may request a version of the content asset to be generated that comprises the unique identifier. Additionally or alternatively, the content asset may be caused to be generated based on the request from the user device.

The version of the content asset may comprise one or more select frames of the content asset embedded with a digital marker. The frames embedded with the digital marker may be randomly selected, such as to deter attempts to remove the digital marker from the version of the content asset by removing a frame comprising the digital marker. The digital marker may be embedded in the majority or all frames of the version of the content asset to prevent removal of the digital marker from the version of the content asset. The digital marker may comprise a watermark or a digital fingerprint. The digital marker may be configured to remain embedded in the one or more frames of the content asset if the content asset is transformed (e.g., converted to analog or digital, frame size is changed, effects are added). Step 530 may be performed before, after, or during step 520.

At step 540, the version of the content asset may be caused to be sent to the user device. For example, the license server 410 in FIG. 4 may cause the version of the content asset to be sent to the user device 402 in FIG. 4. The sending the version to the user device may be based on the determination that the user device is authorized to access the content asset. The sending the version may comprise streaming the version or storing the version to a storage medium accessible to the user device.

At step 550, a distributed ledger record entry may be caused to be stored on in a distributed ledger record of a distributed ledger. The distributed ledger may be similar to any of distributed ledgers 120 in FIG. 1, 200 in FIG. 2, or 300 in FIG. 4. The distributed ledger record entry may be caused to be stored based on the user device 402 requesting the content asset. The distributed ledger record entry may be caused to be stored based on at least the determining that the user device 402 is authorized to access the content asset. For example, the content access manager 416 in FIG. 4 may cause, based on at least the determining that the user device 402 in FIG. 4 is authorized to access the content asset, a distributed ledger record entry to be stored. The distributed ledger record entry may be caused to be stored based on a sending of the content asset to the user device 402.

The distributed ledger record entry may comprise an indication of the content asset. The distributed ledger record entry may comprise an indication of a source of the content asset. The distributed ledger record entry may comprise an indication of the request for the content asset. The distributed ledger record entry may comprise an indication that the content asset or the version of the content asset was sent to the user device. The distributed ledger record entry may comprise an indication that the user device 402 is authorized to access the content asset. The distributed ledger record entry may comprise an indication of a time of the request, of the generation of the version of the content asset, or of the sending of the version to the user device, as examples.

Causing the distributed ledger record entry to be stored on the distributed ledger may comprise sending data indicative of the unique identifier and the content asset to another device. For example, the content access manager 416 in FIG. 4 may send, to the blockchain node 418 in FIG. 4, data indicative of the unique identifier and the content asset. The other device may be configured to generate, based on at least the data, the distributed ledger record entry. For example, the blockchain node 418 in FIG. 4 may be configured to generate, based on at least the data, the distributed ledger record entry.

The distributed ledger record entry may be caused to be stored in a distributed ledger record. For example, if the distributed ledger comprises a blockchain, the distributed ledger record entry may be caused to be stored on a block of the blockchain. For example, the content access manager 416 in FIG. 4 may cause the distributed ledger record entry to be stored on a block of the blockchain.

If the distributed ledger is stored on a plurality of nodes, the distributed ledger record may be sent to at least one node of the plurality of nodes. For example, the content access manager 416 in FIG. 4 may send, to at least the blockchain node 418 in FIG. 4, the distributed ledger record entry. Step 550 may be performed before, after, or during any of steps 520, 530, and 540.

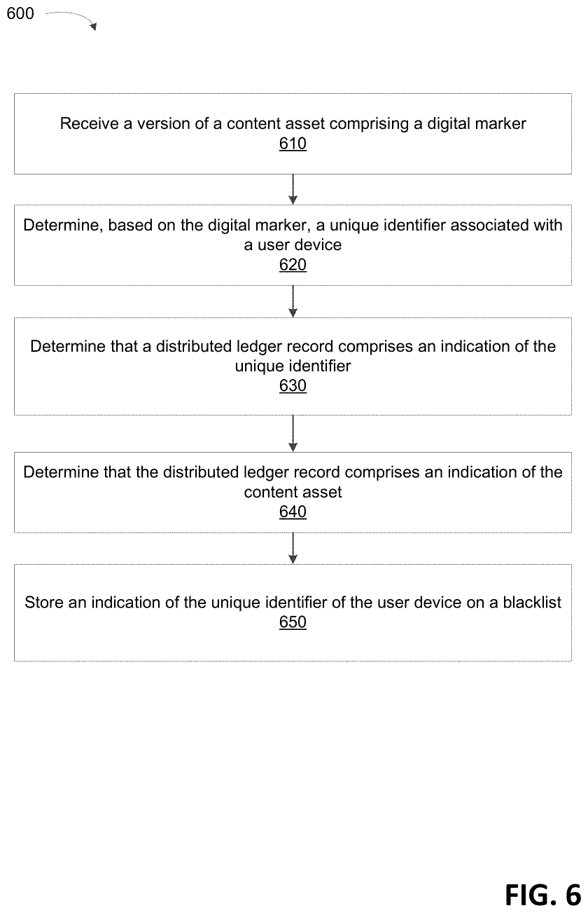

FIG. 6 shows an example method 600. At step 610, a version of a content asset may be received. The version of the content asset may be determined to comprise a pirated version. A pirated version may comprise a version of a content asset that was made, accessed, and/or sent without the authorization of a rights holder of the content asset. The version of the content asset may be received by a computing device associated with a media piracy monitoring service or network. The version of the content asset may comprise a digital marker. The digital marker may comprise a watermark or a digital fingerprint.

The version may comprise a copy of the content asset, such as a potentially pirated copy. The copy may have been extracted from one device to another, such as using a high-definition multimedia interface (HDMI). The copy may have been extracted while the content asset was sent from a content distributor device to a user device or display device (e.g., client device, router, gateway device, set top box, etc.). The copy may be stored on a server. The copy may comprise a transcoded version of the content. The copy may comprise a version of content stored on another device or memory. The copy may comprise a version of the content converted to a different frame size.

At step 620, a unique identifier associated with a user device may be determined based on the digital marker. Determining the unique identifier may comprise performing a digital marker extraction technique on the version of the content asset. The digital marker extraction technique may be based on the type of digital marker or a vendor of the digital marker. For example, digital marker vendors may generate content asset versions comprising digital markers using proprietary technology. The methods of extracting information from the digital markers may be based on the proprietary technology. More than one extraction technique may be performed, such as if it cannot be determined which vendor or digital marker technology was used to generate the version of the content asset and/or the digital marker.

At step 630, a distributed ledger record entry and/or transaction comprising an indication of the unique identifier of the user device may be determined. A distributor or creator of the content asset may be determined. A distributed ledger associated with the distributor or creator may be accessed. The distributed ledger may be searched using the unique identifier of the user device. A transaction and/or record entry comprising the unique identifier of the user device may be located.

At step 640, it may be determined that the distributed ledger record entry and/or transaction comprising the indication of the unique identifier of the user device comprises an indication of the content asset. The indication of the content asset may comprise an indication that the user device requested, accessed, and/or received the content asset. The indication of the content asset may comprise an indication of a time or date that the user device requested, accessed, and/or received the content asset. Based on the distributed ledger record entry and/or transaction comprising the indication of the unique identifier and the indication of the content asset, it may be determined that the user device was a source of the version of the content asset. If the version of the content asset comprises a pirated version, it may be determined that the user device was a source of pirated content. It may be determined that a user associated with the user device is involved in digital content piracy.

At step 650, an indication of the unique identifier may be stored on a blacklist. Based on a determination that the user device was a source of pirated digital content and/or that a user of the device is involved in digital content piracy, the indication of the user device may be stored on the blacklist. The blacklist may comprise a registry and/or a database of user devices associated with digital content piracy. The blacklist may be used to determine to grant access to digital content. For example, a request may be received from the user device to access digital content. Based on the blacklist comprising an indication of the unique identifier of the user device, the request to access digital content may be denied.

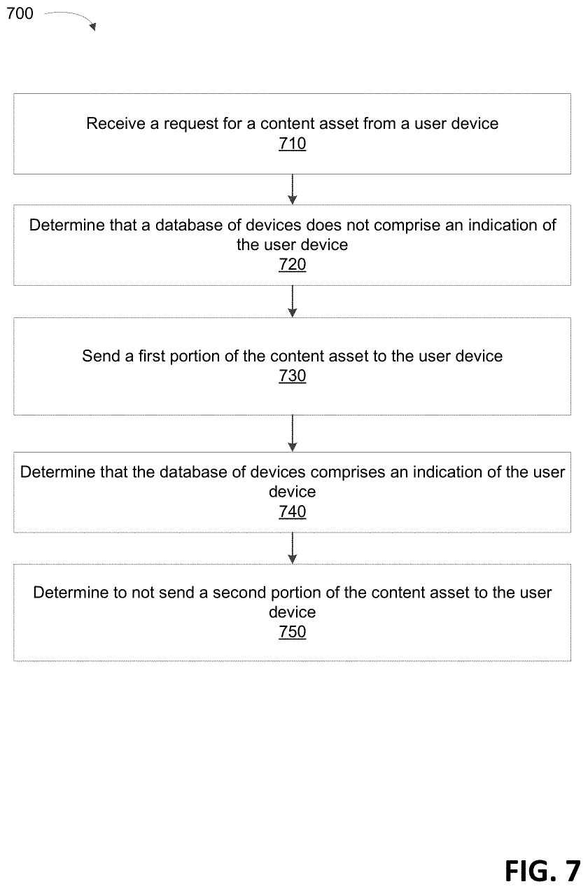

FIG. 7 shows an example method 700. At step 710, a request for a content asset may be received. The request may be received from a user device. The user device may be similar to user device 402 in FIG. 4. The request may be received by a computing device associated with a content distributor, such as the license server 410 in FIG. 4. The request may be similar to the request received in step 510 of method 500. The request may comprise an indication of a unique identifier of the user device. The request may comprise an indication of the content asset. The request may comprise an indication of a first portion of the content asset, such as a portion of the content asset associated with segments of play time of the content asset.

The request may comprise a request for a portion of the content asset, such as for chunks of the content asset. The content asset may be segmented into chunks, such as 1-2 second chunks or 6 second chunks, as examples. Based on the request, steps similar to one or more of steps 520-550 of method 500 may be executed.

At step 720, it may be determined that a database of devices does not comprise an indication of the user device, such as an indication of the unique identifier of the user device. A device associated with the content distributor, such as the license server 410 or the content access manager 416 in FIG. 4. The determining that the database of devices does not comprise the indication of the user device may be based on the receiving the request for the content asset. The database of device may be similar to the blacklist in step 650 of method 600. The database of devices may comprise a blacklist of user devices. The blacklist of user devices may comprise indications of user devices that are not authorized to access content assets. As an example, the blacklist may comprise indications of user devices that are known to have sourced pirated content.

At step 730, a first portion of the content asset may be sent to the user device. The first portion of the content asset may be sent to the user device by a computing device associated with the content distributor, such as the content delivery system 412 in FIG. 4. The first portion of the content asset may comprise a first chunk or plurality of chunks of the content asset. The first portion of the content asset may be sent to the user device based on the determination that the database of devices does not comprise an indication of the user device. The first portion of the content asset may be sent to the user device based on a determination that the user device is authorized to access the content asset. The first portion of the content asset may comprise a first portion of a version of the content asset comprising a digital marker.

At step 740, it may be determined that the database of devices comprises an indication of the user device, such as an indication of the unique identifier of the user device. A device associated with the content distributor, such as the license server 410 or the content access manager 416 in FIG. 4, may determine that the database of devices comprises the indication of the user device. The determining that the database of devices comprises the indication of the user device may be in response to receiving a request for a second portion of the content asset, such as from the user device. The determining that the database of devices comprises the indication of the user device may be performed based on the first portion of the content asset being sent to the user device or being output by the user device. It may be determined that an indication of the user device has been added to the database of devices. For example, the indication of the user device may be added to the database of devices based on determining that the user device distributed content without authorization and/or was involved in other digital content piracy. The determining that the user device participated in digital content piracy may be based on a digital maker comprising an indication of the unique identifier of the user device. The indication of the user device may have been added to the database of devices by a method similar to that of one or more of steps 610-650 of method 600.

At step 750, it may be determined not to send a second portion of the content asset to the user device. A device associated with the content distributor, such as the license server 410 or the content access manager 416 in FIG. 4, may determine not to send the second portion of the content asset to the user device. The second portion of the content may comprise a second portion of chunks of the content asset. For example, the second set of chunks may correspond to segments of play time that follow the segments of play time associated with the first set of chunks sent to the user device. The determination not to send a second portion of the content asset to the user device may be based on the determination that the database of devices comprises the indication of the user device. Based on the determination not to send the second portion of the content asset to the user device, the second portion of the content asset may not be sent to the user device. For example, a streaming of the content asset to the user device may be terminated or interrupted. A determination may be made to not send subsequent portions of the content asset to the user device. Based on the determination not to send the subsequent portions of the content asset to the user device, the subsequent portions of the content asset may not be sent to the user device.

Based on the not sending the second portion or subsequent portions of the content asset to the user device, the content distributor may defend the action. For example, a user associated with the user device may take legal action or file a complaint against the content distributor for the termination and/or denial of access to the content asset. The user may have paid for the content asset and may allege that the content distributor breached a contract or committed another wrong by terminating the access to the content asset. The content distributor may defend or justify the termination of the user's access to the content asset using a distributed ledger entry evidencing that the user device requested, accessed, or received a content asset and using a digital marker embedded in a detected pirated version of the content asset. For example, the content distributor may demonstrate that the content asset indicated in the distributed ledger entry matches the content asset that was pirated. The content distributor may demonstrate that the digital marker comprises an indication of the unique identifier of the user device. The content distributor may demonstrate that the distributed ledger entry indicates that the user device associated with the unique identifier requested, accessed, or received the content asset. The content distributor may also use the distributed ledger entry and the digital marker to take legal action against the user associated with the user device.

As an example, a user may be watching an on-demand movie streamed to the user's laptop computer. 2 second chunks of the movie may be sequentially sent to the laptop computer. During streaming of the movie to the laptop computer, it may be determined that an episode of a television show was uploaded to a website without authorization of a content distributor of the show. It may be determined that the version of the show comprises a watermark comprising an indication of a unique identifier of the laptop computer. A blockchain comprising indications of content assets of the content distributor requested by user devices and unique identifiers of the user devices may be accessed. It may be determined that a transaction on the blockchain comprises an indication of the unique identifier of the laptop computer and an indication of the show. Based on the determination that the transaction indicates the unique identifier of the laptop computer and the show, the unique identifier of the laptop computer may be added to a blacklist of user devices that are not authorized to access digital content of the content distributor.

After the laptop computer may send a request for a subsequent set of chunks of the movie. Based on the request, the blacklist may be accessed. It may be determined that the unique identifier of the laptop computer has been added to the blacklist. Based on the blacklist comprising the indication of the unique identifier of the laptop computer, the request may be denied and the subsequent set of chunks may not be sent to the laptop computer.

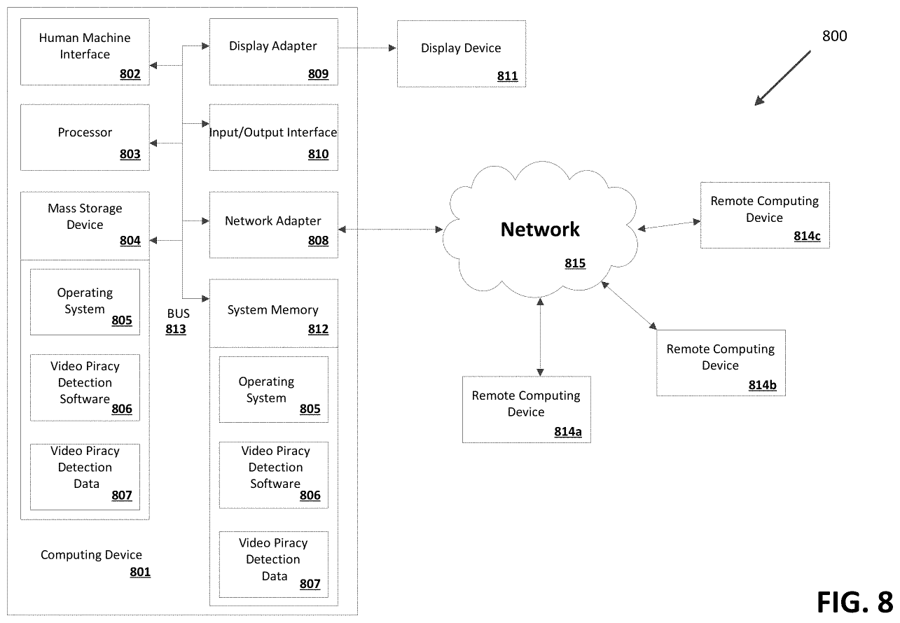

FIG. 8 shows a block diagram illustrating an exemplary operating environment 800 for performing the disclosed methods of content piracy deterrence. This exemplary operating environment is only an example of an operating environment and is not intended to suggest any limitation as to the scope of use or functionality of operating environment architecture. Neither should the operating environment be interpreted as having any dependency or requirement associated with to any one or combination of components shown in the exemplary operating environment.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, etc. that performs particular tasks or implements particular abstract data types. The disclosed methods may be practiced in grid-based and distributed computing environments where tasks may be performed by remote processing devices that are linked through a communications network. In a distributed computing environment, program modules may be located in both local and remote computer storage media including memory storage devices.

Further, one skilled in the art will appreciate that the systems and methods disclosed herein may be implemented via a general-purpose computing device in the form of a computing device 801. The components of the computing device 801 may comprise, but are not limited to, one or more processors or processing units 803, a system memory 812, and a system bus 813 that couples various system components including the processor 803 to the system memory 812. In the case of multiple processing units 803, the system may utilize parallel computing.

The system bus 813 represents one or more of several possible types of bus structures, including a memory bus or memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description may be implemented over a wired or wireless network connection and each of the subsystems, including the processor 803, a mass storage device 804, an operating system 805, digital content piracy deterrence software 806, digital content piracy deterrence data 807, a network adapter 808, system memory 812, an Input/Output Interface 810, a display adapter 809, a display device 811, and a human machine interface 802, may be contained within one or more remote computing devices 814a,b,c at physically separate locations, connected through buses of this form, in effect implementing a fully distributed system.

The computing device 801 typically comprises a variety of computer readable media. Example readable media may be any available media that is accessible by the computing device 801 and comprises, for example and not meant to be limiting, both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as digital content piracy deterrence data 807 and/or program modules such as operating system 805 and digital content piracy deterrence software 806 that are immediately accessible to and/or are presently operated on by the processing unit 803.

The computing device 801 may comprise other removable/non-removable, volatile/non-volatile computer storage media. By way of example, FIG. 8 shows a mass storage device 804 which may provide non-volatile storage of computer code, computer readable instructions, data structures, program modules, and other data for the computing device 801. A mass storage device 804 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 804, including by way of example, an operating system 805 and digital content piracy deterrence software 806. Each of the operating system 805 and digital content piracy deterrence software 806 (or some combination thereof) may comprise elements of the programming and the digital content piracy deterrence software 806. Digital content piracy deterrence data 807 may be stored on the mass storage device 804. Digital content piracy deterrence data 807 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

The user may enter commands and information into the computing device 801 via an input device (not shown). Examples of such input devices may comprise, but are not limited to, a keyboard, pointing device (e.g., a “mouse”), a microphone, a joystick, a scanner, tactile input devices such as gloves, and other body coverings, and the like These and other input devices may be connected to the processing unit 803 via a human machine interface 802 that is coupled to the system bus 813, but may be connected by other interface and bus structures, such as a parallel port, game port, an Institute of Electrical and Electronics Engineers (IEEE) 1394 Port (also known as a Firewire port), a serial port, or a universal serial bus (USB).

A display device 811 may be connected to the system bus 813 via an interface, such as a display adapter 809. It is contemplated that the computing device 801 may have more than one display adapter 809 and the computer 801 may have more than one display device 811. For example, a display device may comprise a monitor, an LCD (Liquid Crystal Display), or a projector. In addition to the display device 811, other output peripheral devices may comprise components such as speakers (not shown) and a printer (not shown) which may be connected to the computing device 801 via Input/Output Interface 810. Any step and/or result of the methods may be output in any form to an output device. Such output may comprise any form of visual representation, including, but not limited to, textual, graphical, animation, audio, tactile, and the like. The display 811 and computing device 801 may comprise part of one device, or separate devices.

The computing device 801 may operate in a networked environment using logical connections to one or more remote computing devices 814a,b,c. By way of example, a remote computing device may comprise a personal computer, a portable computer, a smart phone, a server, a router, a network computer, a peer device or other common network node. Logical connections between the computing device 801 and a remote computing device 814a,b,c may be made via a network 815, such as a local area network (LAN) and a general wide area network (WAN). Such network connections may be through a network adapter 808. A network adapter 808 may be implemented in both wired and wireless environments. Such networking environments are conventional and commonplace in dwellings, offices, enterprise-wide computer networks, intranets, and the Internet.

For purposes of illustration, application programs and other executable program components such as the operating system 805 are shown herein as discrete blocks, although such programs and components may reside at various times in different storage components of the computing device 801 and may be executed by the data processor(s) of the computer. An implementation of digital content piracy deterrence software 806 may be stored on or sent across some form of computer readable media. Any of the disclosed methods may be performed by computer readable instructions embodied on computer readable media. Computer readable media may comprise any available media that may be accessed by a computer. By way of example and not limitation, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

What is claimed is:

1. A method comprising:
receiving, by a computing device and from a user device, an indication of a content asset and an indication of a unique identifier associated with the user device;
determining, based at least on the receiving the indication of the content asset and the indication of the unique identifier, that the user device is authorized to access the content asset;
determining, based at least on the determining that the user device is authorized to access the content asset, a version of the content asset, wherein the version comprises one or more frames of the content asset embedded with a digital marker, and wherein the digital marker comprises an indication of the unique identifier;
causing the version of the content asset to be sent to the user device; and
causing, based at least on the receiving the indication of the content asset and the indication of the unique identifier, a distributed ledger record entry to be stored on a distributed ledger, wherein the distributed ledger record entry indicates the content asset and the unique identifier, wherein the distributed ledger comprises other distributed ledger record entries indicating a plurality of other content assets and a plurality of other unique identifiers associated with other user devices.

2. The method of claim 1, wherein the digital marker comprises a watermark.

3. The method of claim 1, wherein the causing the distributed ledger record entry to be stored comprises sending, to another device, data indicative of the unique identifier and the content asset; and
wherein the another device is configured to generate, based at least on the data, the distributed ledger record entry.

4. The method of claim 1, wherein the method comprises:
determining that another version of the content asset comprises another digital marker;
determining that the another digital marker matches the digital marker; and
causing, based at least on the determining that the another digital marker matches the digital marker, an indication of the unique identifier to be added to a database of devices that are not authorized to access content.

5. The method of claim 4, wherein the method comprises:
receiving, from the user device, an indication of another content asset; and
determining, based at least on the database of devices comprising the indication of the unique identifier, not to authorize the user device to access the another content asset.

6. The method of claim 4, wherein the method comprises:
receiving, from the user device, a request for a first plurality of chunks of another content asset;
sending, to the user device and based at least on a determination that the database of devices does not comprise the indication of the unique identifier, the first plurality of chunks;
receiving, from the user device, a request for a second plurality of chunks of the another content asset;
determining, based at least on a determination that the indication of the unique identifier has been added to the database of devices, not to send the second plurality of chunks to the user device.

7. A method comprising:
receiving, by a computing device and from a user device, an indication of a content asset and an indication of a unique identifier associated with the user device;
causing, based at least on the receiving the indication of the content asset and the indication of the unique identifier, a version of the content asset to be sent to the user device, wherein the version comprises a digital marker, wherein the digital marker comprises an indication of the unique identifier; and
causing a distributed ledger record entry to be stored on a distributed ledger, wherein the distributed ledger record entry indicates the content asset and the unique identifier, and wherein the distributed ledger comprises other distributed ledger record entries indicating a plurality of other content assets and a plurality of other unique identifiers associated with other user devices.

8. The method of claim 7, comprising causing the version of the content asset to be generated by sending a request for the version, wherein the request for the version indicates the unique identifier.

9. The method of claim 7, wherein the distributed ledger record entry comprises an indication of a source of the content asset.

10. The method of claim 7, wherein the distributed ledger comprises a blockchain; and
wherein the causing the distributed ledger record entry to be stored on the distributed ledger comprises causing the distributed ledger record entry to be stored on a block of the blockchain.

11. The method of claim 7, wherein the distributed ledger is stored on a plurality of nodes; and
wherein the causing the distributed ledger record entry to be stored on the distributed ledger comprises sending, to at least one of the plurality of nodes, the distributed ledger record entry.

12. The method of claim 7, wherein the method comprises:
determining that another version of the content asset comprises another digital marker;
determining that the another digital marker matches the digital marker; and
causing, based at least on the determining that the another digital marker matches the digital marker, an indication of the unique identifier to be added to a database of devices that are not authorized to access content.

13. The method of claim 12, wherein the method comprises:
receiving, from the user device, an indication of another content asset; and
determining, based at least on the database of devices comprising the indication of the unique identifier, not to authorize the user device to access the another content asset.

14. The method of claim 12, wherein the content asset comprises a plurality of chunks;
wherein the causing the version of the content asset to be sent to the user device comprises causing a first set of chunks of the plurality of chunks to be sent to the user device; and
wherein the method comprises:
receiving, from the user device, a request for a second set of chunks of the plurality of chunks; and
determining, based on the database of devices comprising the indication of the unique identifier, not to send the second set of chunks to the user device.

15. A system comprising:
a user device configured to:
send an indication of a unique identifier associated with the user device and an indication of a content asset; and
a computing device in communication with the user device, wherein the computing device is configured to:
receive, from the user device, the indication of the unique identifier and the indication of the content asset;
cause, based at least on the indication of the unique identifier and the indication of the content asset, a version of the content asset to be sent to the user device, wherein the version comprises a digital marker, wherein the digital marker comprises an indication of the unique identifier; and
cause a distributed ledger record entry to be stored on a distributed ledger, wherein the distributed ledger record entry indicates the content asset and the unique identifier, wherein the distributed ledger comprises other distributed ledger record entries indicating a plurality of other content assets and a plurality of unique identifiers associated with other user devices.

16. The system of claim 15, wherein the computing device is configured to:
determine that another version of the content asset comprises another digital marker;
determine that the another digital marker matches the digital marker; and
cause, based at least on the determining that the another digital marker matches the digital marker, the unique identifier to be added to a database of devices that are not authorized to access content.

17. The system of claim 15, wherein the distributed ledger record entry comprises at least one of an indication of a source of the content asset, an indication of a date that the version of the content asset was generated, or an indication of a time that the version of the content asset was generated.

18. The system of claim 15, wherein the computing device is configured to cause, based at least on the indication of the unique identifier and the indication of the content asset, the distributed ledger record entry to be generated.

19. The system of claim 15, wherein the plurality of other content assets comprise content assets accessed by the other user devices.

20. The system of claim 15, wherein the computing device is configured to:
determine that another version of the content asset comprises another digital marker;
determine that the another digital marker comprises the unique identifier; and
cause, based at least on the determining that the another digital marker comprises the unique identifier, an indication of the unique identifier to be added to a database of devices that are not authorized to access content.
